(19) United States
(12) Patent Application Publication
(10) Pub. No.: US 2002/0080821 A1
(43) Pub. Date: Jun. 27, 2002

(54) ATM SAR (asynchronous transfer module segmentation and reassembly) module for an xDSL communication service chip

(76) Inventor: Dae-Hwan Hwang, Taejon (KR)

Correspondence Address: JACOBSON, PRICE, HOLMAN & STERN, PROFESSIONAL LIMITED LIABILITY COMPANY, 400 Seventgh Street, N.W., Washington, DC, 20004, US

(21) Appl. No.: 09/824,065

(22) Filed: Apr. 3, 2001

(30) Foreign Application Priority Data
Dec. 22, 2000 (KR) 2000-80738

(51) Int. Cl. H04J 3/24

(52) U.S. Cl. 370/474

(57) ABSTRACT

The present invention is to provide an improved efficiency of transmission and reception for data in an ATM SAR (Asynchronous Transfer Mode Segmentation and Reassembly) module for a xDSL communication service chip.

The ATM SAR module comprises a memory controller controlling signals, a generation module for transmitting a CRC32 that is a block to generate 32 bits CRC (cyclic redundancy check) block necessary for an AAL-5 PDU to check a transmission error of the AAL (ATM Adaptation Layer)-5 PDU (Protocol Data unit) in a virtual channel unit, a generation module for receiving a CRC32 to check a reception error of the AAL-5 PDU, a generation modules for transmitting and receiving a CRC10 to process the OAM (Operation, Administration and Maintenance) cell, a header manager module to add and analyze an ATM header according to the virtual channel setup information of the AAL-5 PDU, an UTOPIA interface module to provide a standard connection with an external physical module, an ATM SAR state machine controlling whole operations of the ATM SAR and a packet memory to store data that the ATM SAR has to transmit or is received through the ATM SAR. Using the packet memory, data exchange between the ATM SAR and peripheral devices is optimally performed.

### Field of the Invention

The present invention relates to an ATM SAR (Asynchronous Transfer Module Segmentation and Reassembly) module for a xDSL (including all Digital Subscriber Line technologies) communication service chip; and, more particularly, to an ATM SAR module for a xDSL communication service chip capable of improving efficiency for data transmission and reception.

### DESCRIPTION OF THE PRIOR ART

There are provided some methods for using an internet service at an office and home. The methods are implemented through a private internet network, after building such a private network, or a telephone line. A local area network and the private network are usually used at the office; however, it is difficult to use the above-mentioned networks because of a high cost. The internet network through the telephone line is used in the small business at a low cost; however, a limited bandwidth of the telephone line makes it difficult to provide a high-speed internet service.

A rising solution for these problems is an xDSL technology which receives a plurality of information with a downward high-speed communication band of a few mega bps by using the present telephone- line. The xDSL (including all digital subscriber line technologies) pattern may be divided into an ADSL (Asymmetrical Digital Subscriber Line), an UADSL (Universal Asymmetrical DSL), a VDSL (Very high-data rate DSL) and a HDSL (High-data rate DSL). Because the xDSL has advantages in that a cable grappling for a new line is not needed and traffic characteristics of internet users are easily acceptable, the xDSL has been considered as the most realizable method of accepting a multi media service to have a plurality of information bands in a data service for texts and simple graphics.

A conventional xDSL communication service chip for directly sharing a communication match with each subscriber at the small office or home and providing various communication services, such an internet TV, will be described. Also the configuration of an ATM SAR (Asynchronous Transfer Mode Segmentation and Reassembly) will be described in a dual xDSL media access method.

FIG. 1 is a schematic diagram illustrating a communication system using an xDSL communication chip. As shown in FIG. 1, the xDSL communication chip for a SOHO (Small Office/Home Office) has been used for embodying a built-in modem to connect a general-purpose PC to an internet network and for embodying VoIPs (Voice over Internet Protocols) and AV (Audio Visual) terminals that become very popular in a real time internet service. Also, the xDSL communication chip has been used to embody a simple router for the SOHO sharing each resource and external network in the small office and home networks.

Generally, a path of the ATM SAR, which is a standard of the xDSL media connection, is used in order that each information for the xDSL communication chip is connected to an external network. An optimum data exchange in the ATM SAR between the suppliers and consumers of the information and the ATM SAR, is an important factor to decide an efficiency of the xDSL communication chip and a service quality provided to users.

The ATM SAR is a kind of a MAC (Medium Access Control) which is established as a standard for the xDSL physical media. Various types of commercial chips have been already produced in domestic and international markets according to the function of the ATM SAR. Traffic, which is generated in the office or home, and external traffic through the xDSL network have to be controlled effectively to apply and use the ATM SAR at the xDSL communication service chip for the SOHO. A configuration for the optimum data exchange between a generation part and a reception part of the information has to be accomplished.

The conventional ATM SAR, which is used as either an ATM subscriber's adaptor type used at terminals or a specific application included in the ATM switch fabric, have a low efficiency for the data exchange.

FIGS. 2 to 4 are block diagrams of various configurations of conventional ATM SARs.

FIG. 2 is a configuration, in which an ATM SAR 200 processes user data through a FIFO 220 of a fixed size. Signals in a type of information are processed through the FIFO 220, an AAL (ATM adaptation Layer) processing part 230, an ATM layer processing part 240 and an UTOPIA interface.

Even if the simple configuration in FIG. 2 has an advantage, it has a problem in that the efficiency of the ATM SAR 200 depends on the size of the FIFO 220. In case of a single virtual channel, a constant efficiency may be maintained. But, in case that the ATM cells are transmitted and received at the same time through a multi virtual channel, a function for dividing and integrating information for each virtual channel is needed. The data transmission and reception efficiency are decreased by an excessive control information exchange between the ATM SAR 200 and the processor to control the function.

To solve a demerit illustrated in FIG. 2, FIG. 3 provides another ATM SAR configuration storing data of each virtual channel to be transmitted and received at the same time by setting an external high-speed control memory 350, such as a SRAM or a DRAM, and also is a configuration storing all of the maximum transmission and reception AAL packets, which are needed per the virtual channel.

As shown in FIG. 3, since an external processor exchanging data transmits a high-speed data, independent of an ATM SAR 300 operation, and the received data are processed according to the assigned ATM traffic characteristics, the configuration in FIG. 3 has a merit of a data transmission, as compared with that in FIG. 2; however, a necessary capacity of the external universal high-speed control memory 350 has to be dramatically increased according to the number of virtual channels, which the ATM SAR 300 supports, and a size of the maximum AAL packet.

To solve the problem illustrated in FIG. 3, FIG.4 shows a further another conventional ATM SAR configuration which is generally applied to a PC-type ATM network card built in a slot of a universal PC. An external universal scheduler memory 460 of an ATM SAR 400 uses a minimum memory for temporarily storing data of an ATM header and multi channels. Namely, the configuration in FIG. 4 controls table information according to a VPI (Virtual Path Identifier) and a VCI (Virtual Channel Identifier) of the ATM virtual channel which an user demands. The data inputted and outputted through a path of the virtual channel are shared through a host bus and a large capacity memory.

The configuration in FIG. 4 has an advantage in that the ATM SAR 400 has a minimum memory and can efficiently process the ATM data that is inputted and outputted through the path of multi virtual channels. However, this configuration has a demerit in that it can be applied to only a specific environment required in the universal PC including the high-speed external system bus.

As mentioned above, when considering a specific environment for the xDSL communication chips, the efficient data processing cannot be expected in the conventional ATM SAR configurations of FIGS. 2 to 4. Accordingly, the ATM SAR configuration has to be decided under the consideration of the following data exchange type.

FIGS. 5 and 6 are block diagrams illustrating flow types of signals between the ATM SAR and a peripheral I/O showing examples of the data exchange between a SOHO network module 520, such a HomePNA (Home Phone Line Networking Alliance) or a LAN, and the ATM SAR based on an inner environment of the xDSL communication service chip.

Referring to FIG. 5, the data exchange between the SOHO network module 520, such a HomePNA or a LAN, and the ATM SAR module requires two operations, writing and reading operation, in a host main memory 500 connected to a system bus through a processor or a DMA (Direct Memory Access) controller. In the SOHO network module 520, the data to be transmitted to an external internet network is temporarily written in the host main memory 500 to be transmitted to an external internet network. When the ATM SAR module processes the data, the system bus is used twice for a data transmission by reading the data of the host main memory 500 and writing the data in an ATM SAR memory 510. The system, including the peripheral I/O devices connected to the processor and the processor bus, sends the corresponding I/O data to the process module through the system bus and sends the processed data again to the corresponding peripheral I/O device. In order to improve the efficiency of the whole system, it is important to efficiently process the system bus over the high-speed process function for the process module. At this point, because the system bus in FIG. 5 is inefficiently processed, the data exchange between the SOHO network module 520, such as the HomePNA network or the LAN, and the ATM SAR module may decrease the efficiency of the whole system.

FIG. 6 shows a configuration as a method for improving the demerit in FIG. 5, including a private bus between a SOHO network module 620 and the ATM SAR module. In FIG. 6, the minimum information, which the processor has to process, is sent to a host main memory 600 and the information is sent to the corresponding module after operation thereof. At this time, the information, which is not required to be changed, is exchanged through the private bus directly connected two modules, the SOHO network module 620 and the ATM SAR module. The signal processing to provide the internet service between the SOHO network module 620 and the ATM SAR module will be described. The cell type information inputted through the ATM module is combined into an original AAL packet by the ATM module. The data combined into the AAL packet is processed in an internet protocol packet corresponding to the SOHO network. After the processor processes only the header and control information required in the SOHO network module 620, the information is transmitted to the SOHO network module 620 in synchronization with user information that is transmitted through the private bus of the ATM SAR module and the SOHO network module 620.

The data exchange of FIG. 6 prevents the excessive occupation of the system bus, because the system bus is used only for exchanging control information which has to be processed and changed. Because the system bus can be used by other I/O devices, it has an advantage to efficiently manage resources. However, there is a problem in that a hardware logic and control protocols for an additional private bus, which are installed between the ARM SAR and the SOHO network module, is required with a complexity of the system.

### SUMMARY OF THE INVENTION

It is, therefore, an object of the present invention to provide an ATM SAR module for an xDSL communication service chip for improving an efficiency of a data transmission and reception.

In accordance with an aspect of the present invention, there is provided an ATM SAR module for an xDSL communication service chip comprising a memory controller for generating a control signal for accessing a packet memory, a generation module for transmitting a CRC32 that is a block to generate 32 bits CRC (Cyclic Redundancy Check) block necessary for the AAL (ATM adaptation Layer)-5 PDU (Protocol Data Unit) and calculating the AAL-5 PDU in a virtual unit, a generation module for receiving the CRC32 that is a block to check an error of the AAL-5 PDU inputted through the other network, equally performed with the transmission part, a generation module for transmitting and receiving a CRC10 that processes the OAM (Operation, Administration and Maintenance) cell, similarly performed with the CRC32 process, a header manager module for adding or analyzing 4 octets ATM header according to virtual channel setup information of a transmitted the AAL-5 PDU and data types (AAL-5 PDU or OAM cell) to be processed, a UTOPIA interface controller providing a standard connection between the ATM SAR and a physical module, an ATM SAR state management machine for controlling the whole operations of the ATM SAR and a packet memory storing data to be received or transmitted through the ATM SAR.

### BRIEF DESCRIPTION OF THE DRAWINGS

The above and other objects and features of the present invention will become apparent from the following description of preferred embodiment given in conjunction with the accompanying drawings, in which:

FIG. 1 is a diagram showing an example using a xDSL communication chip;

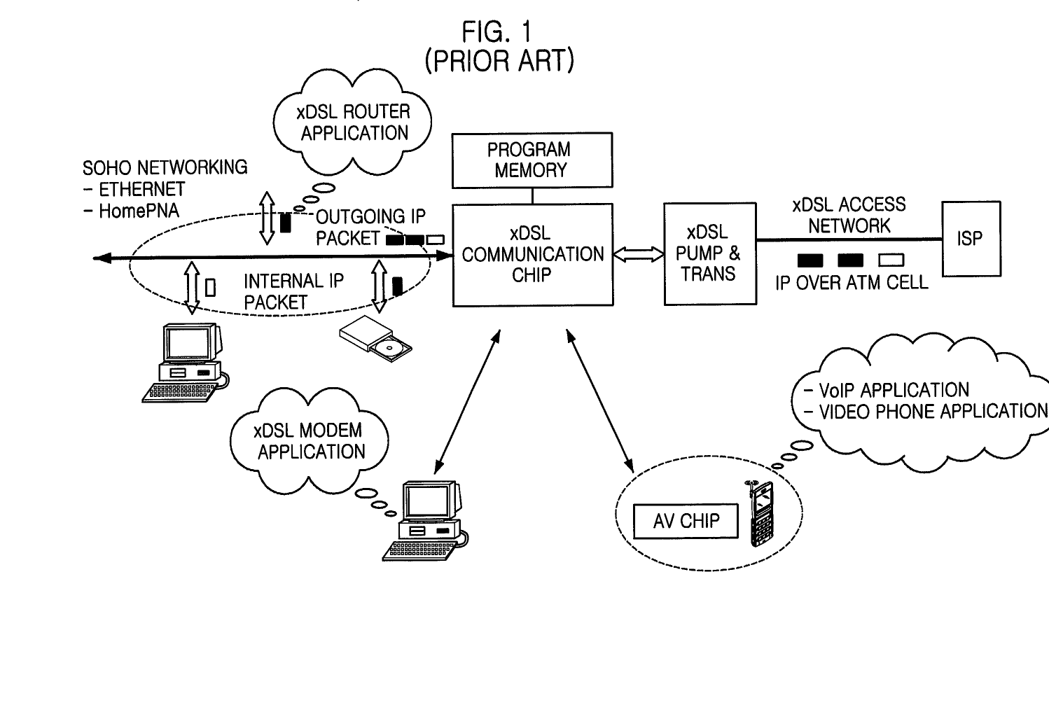

FIG. 2 is a block diagram illustrating a conventional ATM SAR;

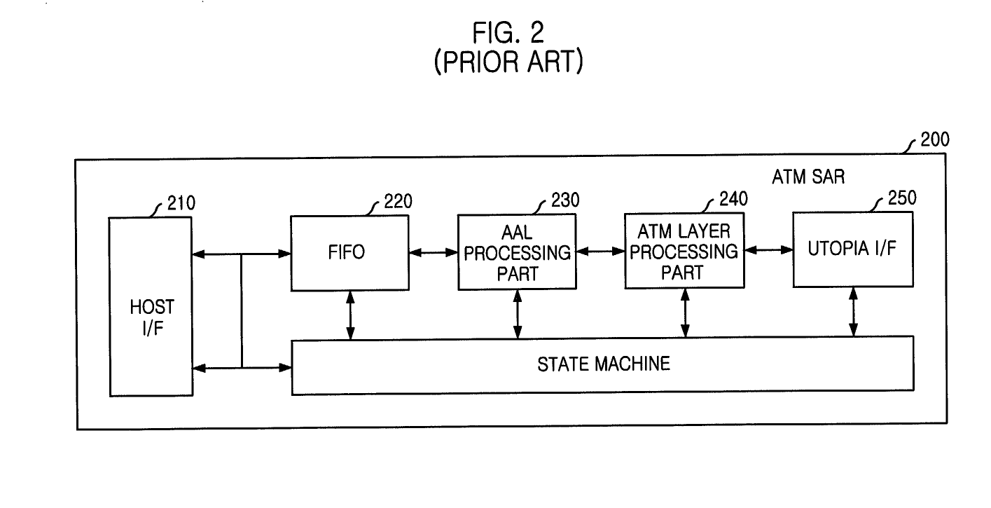

FIG. 3 is another block diagram illustrating a conventional ATM SAR;

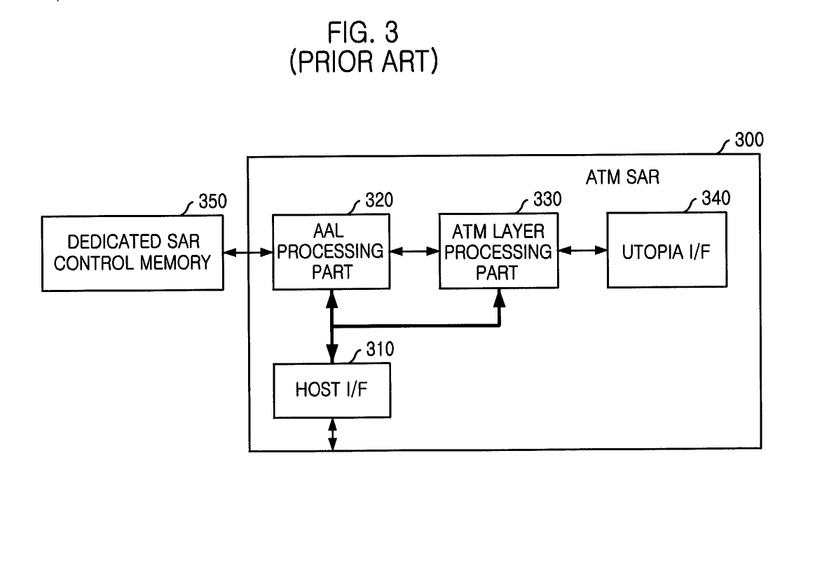

FIG. 4 is further another block diagram illustrating a conventional ATM SAR;

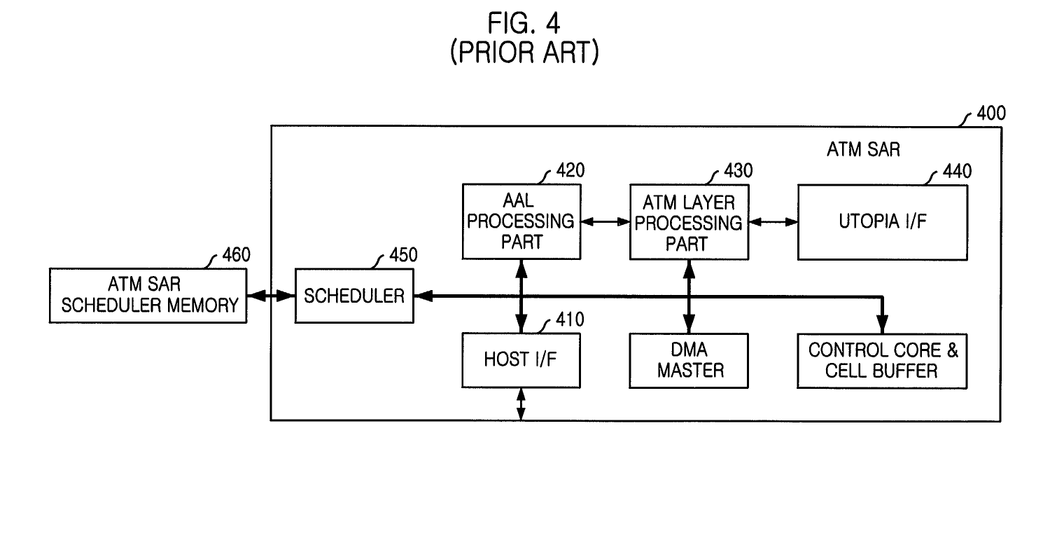

FIG. 5 is a block diagram showing signal flow between an ATM SAR and a peripheral I/O device;

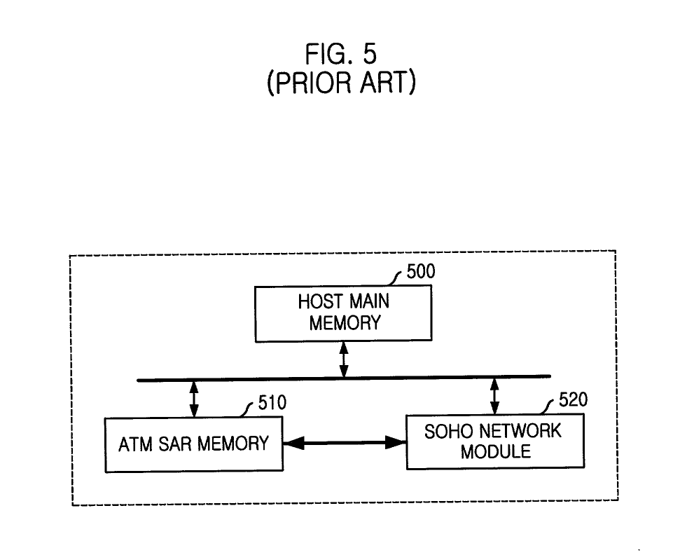

FIG. 6 is another block diagram showing signal flow between an ATM SAR and a peripheral I/O device;

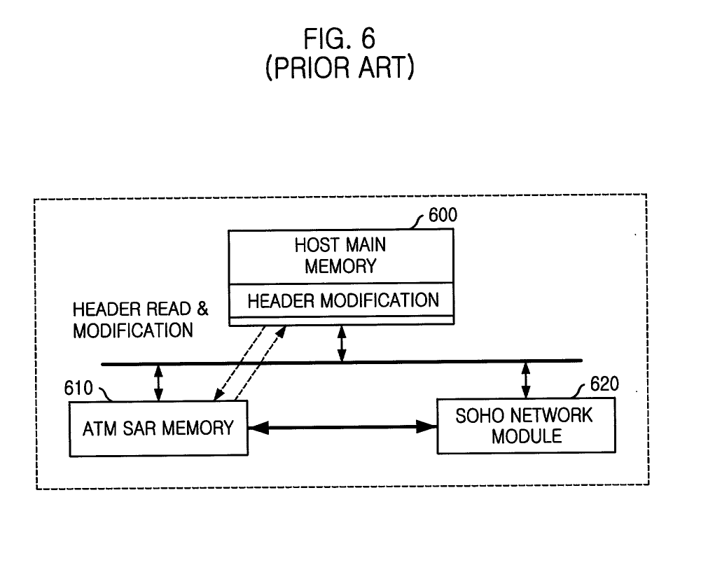

FIG. 7 is a diagram illustrating a hardware configuration of an ATM SAR module according to the present invention;

FIG. 8 is a block diagram showing a type of signal flow of an ATM SAR module according to the present invention;

FIG. 9 is a diagram showing an operation state of an ATM SAR module according to the present invention;

FIG. 10 is a block diagram illustrating a xDSL communication service chip applied an ATM SAR module according to the present invention.

### DETAILED DESCRIPTION OF THE PREFERRED EMBODIMENTS

Hereinafter, an ATM SAR (Asynchronous Transfer Module Segmentation and Reassembly) module according to the present invention will be described in detail referring to the accompanying drawings.

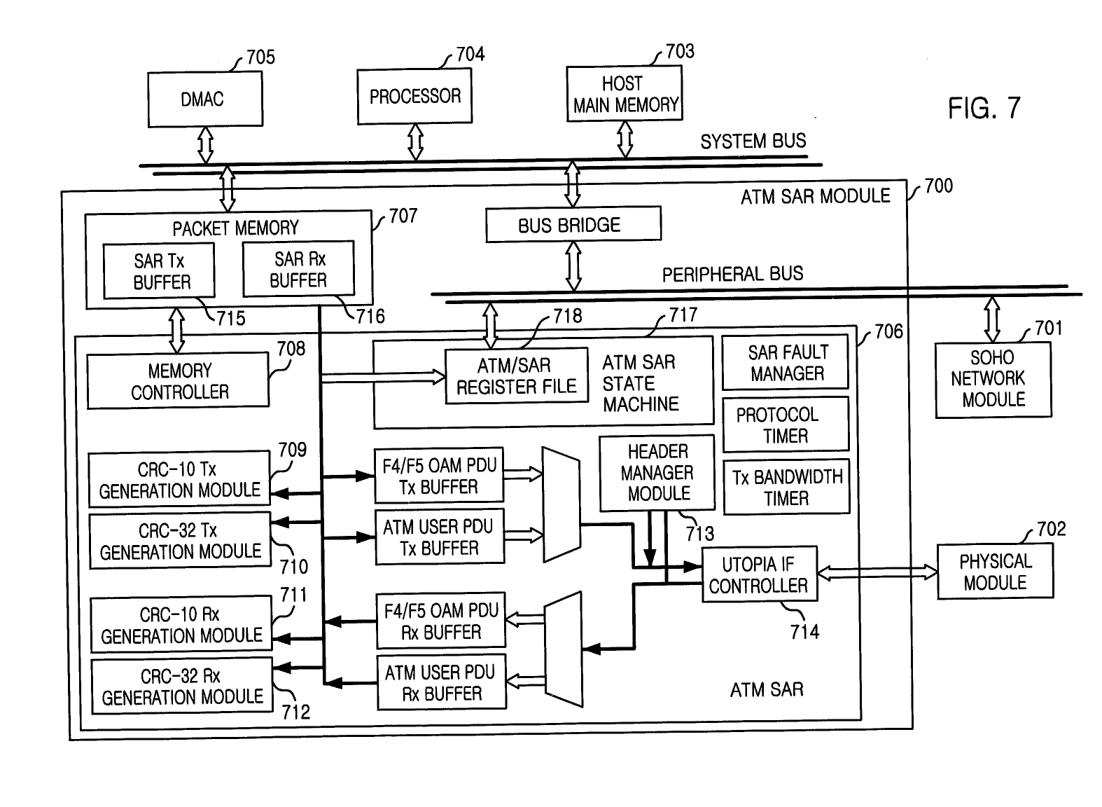

FIG. 7 is a diagram showing a hardware configuration of an ATM SAR module 700 including an ATM SAR 706 and a packet memory 707 according to the present invention. In FIG. 7, to explain an operation of the ATM SAR module 700, a processor 704 for processing data necessary for controlling the whole xDSL communication service chip, a host main memory 703, a DMA (Direct Memory Access) controller 705, a SOHO (Small office/Home office) network module 701 and a physical module 702 are described, in addition to the ATM SAR module according to the present invention.

In the ATM SAR 706, a memory controller 708, as a module generating control signals required in reading and writing data in the packet memory 707, generates control signals for addressing, chip selecting, writing and reading operations.

Data types that the ATM SAR 706 processes are an AAL (ATM Adaptation Layer) PDU (Protocol Data Unit) for receiving and transmitting a general data and an OAM (Operation, Administration and Maintenance) data of F4 (VP: Virtual Path level)/F5 (VC: Virtual Channel level) levels for maintenance and management. Transmission and reception of the AAL PDU is performed through path of the packet memory and transmission and reception of the OAM data is performed by an operation directly writing and reading data in the OAM transmission and a reception register 718 in the ATM SAR 706.

A generation module 710 for transmitting a CRC32, which is a block to generate 32 bits CRC (Cyclic Redundancy Check) block necessary for the AAL-5 PDU, calculates the AAL-5 PDU in a virtual channel unit.

A generation module 712 for receiving the CRC32 that is a block to check an error of the AAL-5 PDU inputted through the other network is equally performed with the transmission part 710.

Generation modules 709 and 711 for transmitting and receiving a CRC10 that processes the OAM cell is similarly performed with the CRC32 process.

A header manager module 713 adds or analyzes 4 octets ATM header according to the data types (AAL PDU or OAM cell) to be processed and the virtual channel setup information of the AAL PDU to be transmitted.

A UTOPIA interface controller 714 provides a standard connection with an external physical module 702.

An ATM SAR state machine 717 controls all of operations for the ATM SAR 706.

A packet memory 707, that is a dual port memory storing the data that the ATM SAR 706 has to transmit or the data that is received through the ATM SAR 706, includes a SAR transmission (Tx) buffer 715 and a SAR reception (Rx) buffer 716.

A size assignment for the SAR Tx buffer 715 and the SAR Rx buffer 716 can be asymmetrically assigned according to traffic characteristics of the virtual channels that are set up at the same time. An initial size assignment of the SAR Tx buffer 715 and the SAR Rx buffer 716 is reset dynamically according to the virtual channel assignment.

An operation of the ATM SAR module 700 for transmission and reception will be described. Data Transmission starts with transmission of IP (Internet Protocol) packet inputted through the LAN or the HomePNA (Home Phone Line Networking Alliance) module through the xDSL network. Data generated from the SOHO network module 701 is stored in the SAR Tx buffer 715 by the DMA controller 705 or the processor 704. After processing protocols for data in the SAR Tx buffer 715, the processor 704 fixes a packet position corresponding to the virtual channel in order to demand the AAL PDU transmission and notifies the packet size to be transmitted and an initial address of the SAR buffer 715.

The ATM SAR 706 receiving information from the processor 704 divides the data on a 48-octets basis and performs the CRC32 calculation to check the transmission error of data at the same time. The AAL-5 PDU includes trailer information including whole packet's length to form a frame corresponding to the AAL-5 protocol and a CPCS-UU (Common Part Conversion Sub-Layer User to User).

The AAL-5 PDU divided in 48 octets is made to 53 octets ATM cell type including the 4 octets ATM header (VPI (Virtual Path Identifier), VCI (Virtual Channel Identifier)) corresponding to the virtual channel and 1 octet HEC (Header Error control) part processed to null data and sent to the physical module 702. The ATM SAR state machine 717 manages traffic for the virtual channel of the ATM SAR module 700 and processes service data for each virtual channel stored in the SAR Tx buffer 715 in the ATM cell unit, considering an average bandwidth for the virtual channel and maximum cell rate initialized in virtual channel setup procedure.

Reception of the AAL-5 PDU is opposed to its transmission. Data inputted in the ATM cell type from the physical module 702 is received in the ATM SAR 706 through the UTOPIA controller 714. The virtual channel corresponding to the data is confirmed through a header analysis procedure of the head manager module 713. The data is classified into corresponding virtual channels according to the data information and the CRC32 and trailer processing are performed. Reassembly work of the AAL-5 PDU inputted in each virtual channel is finished in the SAR Rx buffer 716. The data transmission is completed, as the ATM SAR 706 notifies relative information of the data reception to the processor 704.

The information stored in the SAR Rx buffer 716 is directly sent to the SOHO network module 701 under control of the processor 704 or the DMA controller 705 via a simple treatment including the header information for sending the information to the SOHO network module 701.

The OAM cell is processed by the ATM SAR 706 according to the ATM register file, transmitted and received without using the packet memory path. Because the ATM cell includes just a little information for maintaining and managing the data of F4/F5 levels, the processor 704 can easily process the data.

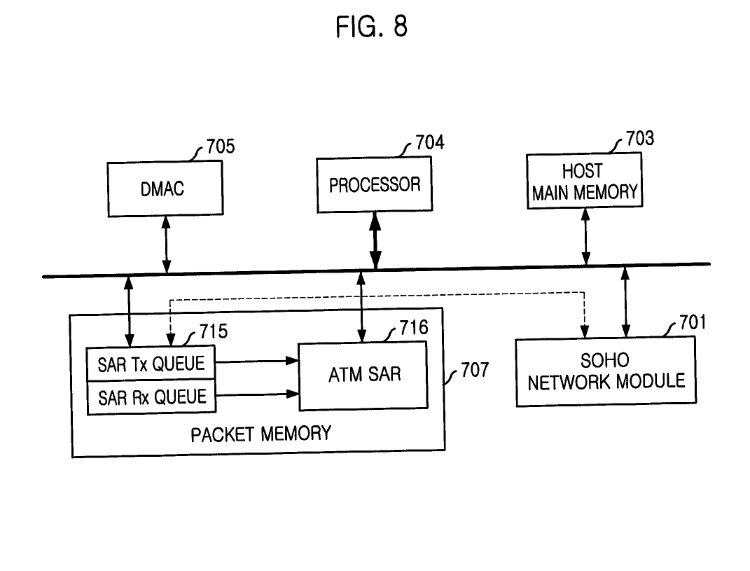

FIG. 8 is a diagram showing a signal flow of the ATM SAR 716 according to the present invention. In the present invention, the packet memory 715 for exchanging the data between the ATM SAR 716 and the SOHO network module 701 is used. The packet memory 715 connects a system bus of the xDSL communication service chip with the ATM SAR 716. Also, the packet memory is used to a dual port RAM that the processor 704 and the ATM SAR 716 can be accessed and controlled at the same time. In case of a conventional data flow, the data in the SOHO network module is sent to the host main memory and the processor processes the data stored in the host main memory in order to transmit and receive the data between the SOHO network module and the ATM SAR and the data is finally sent to the ATM SAR so that the system bus is used twice. However, in the present invention, the data exchange between the SOHO network module 810 and the ATM SAR 800 is performed through the packet memory 850. The processor 830 directly processes the data stored in the packet memory 850 and sends the data to the ATM 800 and the SOHO network module so that the system bus is used one time.

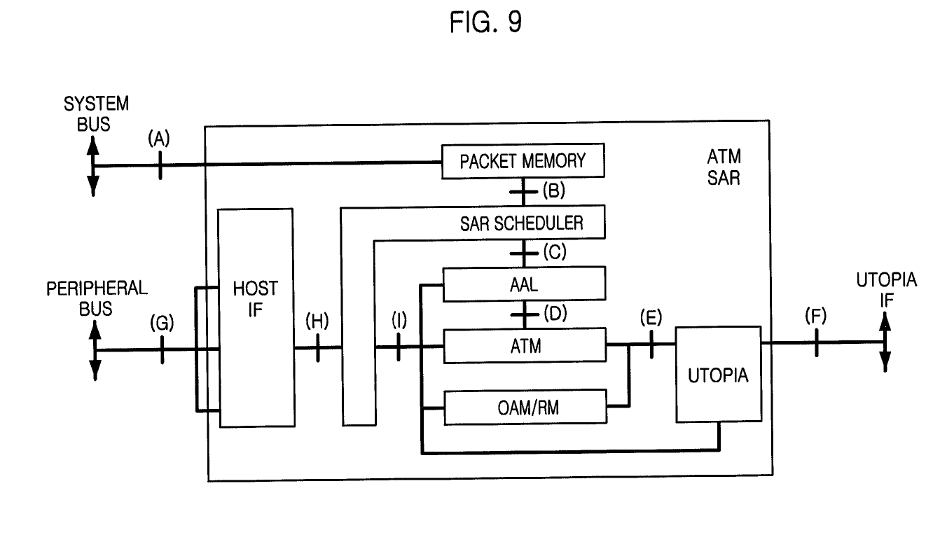

FIG. 9 is a block diagram showing a signal flow among the inner blocks in the ATM SAR. The information exchange between the SOHO network and a general user is performed through the interface (A), (B), (C), (D), (E) and (F). The initialization and the state notification of the ATM SAR and the management of the ATM SAR through the processor are performed through the general host interface (G). Transmission and reception of the OAM cell is performed through the (G), (H), (I), (J) and (K) path.

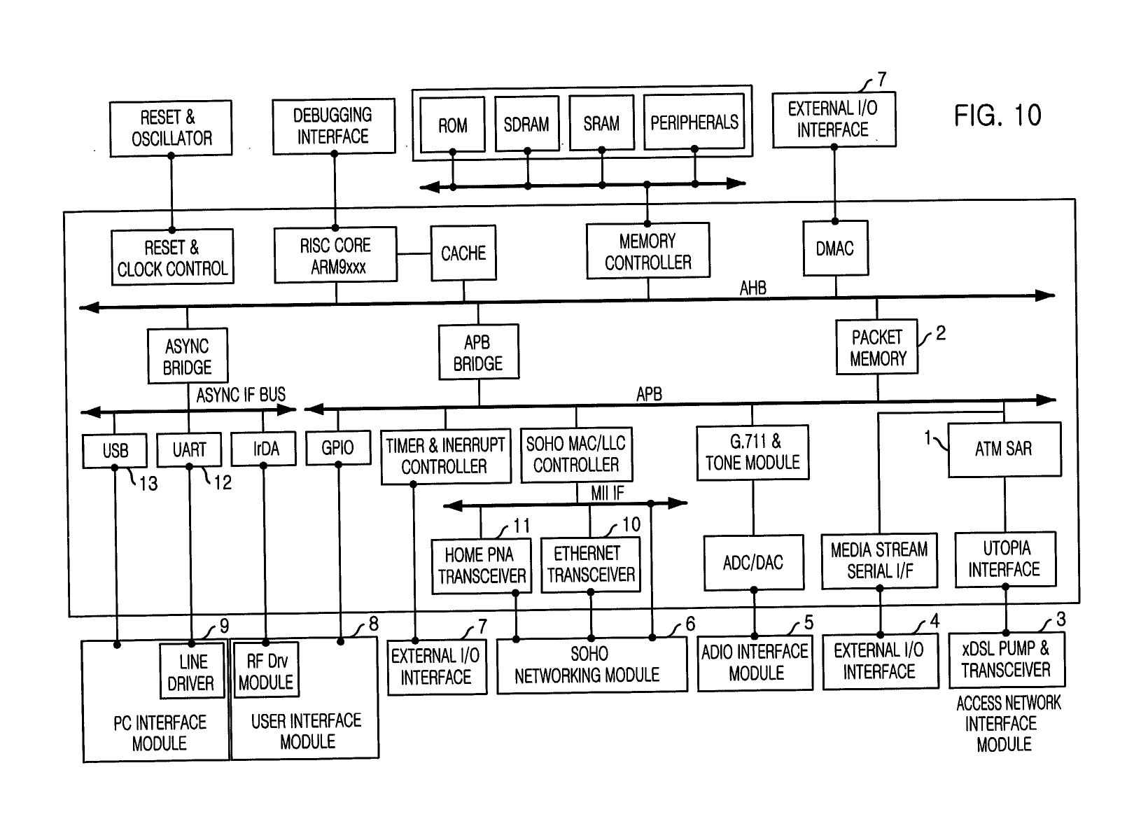

FIG. 10 is a function block diagram illustrating the xDSL communication chip applying the ATM SAR module according to the prevent invention. The configuration of the xDSL communication service chip, as described in FIG. 10, comprises an ATM SAR 1, a packet memory 2, an USB 13, an UART 12, a HomePNA transceiver 11, an Ethernet transceiver 10, a processor module controlling the chip function, a SOHO network module 6 that can configure a HomePNA and an Ethernet network, a PC interface module 9, a user interface module 8, an external I/O interface module 4, a access network interface module 3 and the audio interface module 5.

Paths for the information flow of the xDSL communication service chip, as described in FIG. 10, are a path through the USB 17 and the UART 18, the path for real time communication between the VOIP and the AV and a path for supply and consumption of resources shared between the office and home through the HomePNA transceiver and Ethernet transceiver.

The present invention describes the hardware configuration of the ATM SAR for media connecting capable of being directly applied at the xDSL communication chip. The conventional ATM SAR, which can be widely used for general applications, has a limited efficiency and utility for the data flow of the system. The improved efficiency of the chip cannot be expected, because the general configuration, applied the xDSL communication chip of the present invention, causes an excessive use of the system bus and a complication of the configuration. The present invention to solve the demerits and improve the chip efficiency of a conventional ATM SAR minimizes the processor or the DMA controller access through addition of the data transmission and reception packet memory in the ATM module. The above configuration is accompanied with improved efficiency of the data exchange and the simplification of the external memory configuration for processing the packet of the ATM SAR module. The xDSL communication chip efficiency can be improved through minimum the system bus use for data transmission and reception and reduction of the ATM SAR module process load that the processor has to process.

The present invention will be applied to applications, such as the xDSL modem, the VoIP, and a SOHO router that is used the internet service after building the network in the small office, home, and personal user using the xDSL network. The configuration and the efficiency of the ATM SAR, transmitting and receiving the data via the xDSL applying the application services, affect the quality of the communication service. The built-out and built-in xDSL modem receives and transmits the PC data through the UART and the USB. The communication service of the VOIP, the AV terminal and the router for the SOHO is operated through the data reception and transmission with the AV codec or the LAN and HomePNA module. As the present invention proposes the efficient configuration of the ATM SAR that is suitable for the much information flow, the xDSL communication service and the main application service are applied. The present invention will be applied to the new application with reduction of the excessive load for the processor and the system.

While the present invention has been described with respect to the particular embodiments, it will be apparent to those skilled in the art that various changes and modifications may be made without departing from the spirit and scope of the invention as defined in the following claim.

What is claimed is:

1. An ATM SAR (Asynchronous Transfer Mode Segmentation and Reassembly) module for a xDSL communication service chip, comprising:
a memory control means for generating a control signal for accessing a packet memory;
a generation means for transmitting a CRC32, which is a block to generate 32 bits CRC (Cyclic Redundancy Check) block necessary for the AAL (ATM adaptation Layer)-5 PDU (Protocol Data Unit) and calculating the AAL-5 PDU in a virtual unit;
a generation means for receiving the CRC32 that is a block to check an error of the AAL-5 PDU inputted through the other network;
a CRC10 processing means for transmitting and receiving a CRC10 that processes the OAM (Operation, Administration and Maintenance) cell;
a header manager means for adding or analyzing 4 octets ATM header according to virtual channel setup information of a transmitted the AAL-5 PDU and data types (AAL-5 PDU or OAM cell) to be processed;
an UTOPIA interface means for controlling a standard connection between the ATM SAR and a physical module;
an ATM SAR state management means for controlling whole operations of the ATM SAR; and
a packet memory means for storing data to be received or transmitted through the ATM SAR

2. The ATM SAR module as recited in claim 1, wherein the packet memory means is a dual port memory.

3. The ATM SAR module as recited in claim 2, wherein the packet memory means includes a transmission and reception packet memories.

4. The ATM SAR module as recited in claim 3, wherein the transmission and reception packet memories are memories which are symmetrically assigned according to traffic characteristic of a virtual channel to be set up at the same time.

5. The ATM SAR module as recited in claim 4, wherein the transmission and reception packet memories are dynamically re-assigned according to a virtual channel assignment.
